(19) United States
(12) Patent Application Publication
(10) Pub. No.: US 2015/0066540 A1
(43) Pub. Date: Mar. 5, 2015

(54) METHOD AND COMPUTING DEVICE FOR PROVIDING MEDICATION INFORMATION IN CONJUNCTION WITH AN ELECTRONIC HEALTH RECORD

(71) Applicant: McKesson Financial Holdings, Hamilton (BM)

(72) Inventors: Skyler Wason, Chapel Hill, NC (US); Francis Beaudet, Gatineau (CA)

(73) Assignee: McKesson Financial Holdings, Hamilton (BM)

(21) Appl. No.: 14/011,228

(22) Filed: Aug. 27, 2013

(51) Int. Cl. G06F 19/00

(52) U.S. Cl. CPC G06F 19/3456; G06F 19/322
USPC 705/4

(57) ABSTRACT

A method, computing device and computer program product are disclosed to provide medication information in conjunction with an electronic health record of a patient. In the context of a method a user is permitted to access the electronic health record of the patient and a medication catalog is displayed within the electronic health record of the patient. The medication catalog includes a current medication listing of one or more current medications for the patient, a historical medication listing of one or more historical medications for the patient and a favorites listing of one or more favorite medications of the user. The method also includes receiving user input via a selection of a respective medication included in the current medication list, the historical medication listing or the favorites listing in order to alter a prescription of the patient.

### TECHNOLOGICAL FIELD

An example embodiment relates generally to an electronic health record and, more particularly, to the provision of medication information in conjunction with the electronic health record of a patient.

### BACKGROUND

Electronic health records are being increasingly utilized in order to maintain electronic documentation associated with a patient's medical history. At least some electronic health records include prescription modules. A prescription module may identify the medications that the patient is currently taking and may permit the prescriptions for the medications to be renewed by a physician or other healthcare professional. Prescription modules may also provide other information regarding medications that a patient has taken and may further facilitate the writing of a new prescription for the patient by a physician or other healthcare professional. However, the prescription modules utilized by electronic health records have not always provided the information regarding medications in a manner that was either efficient or intuitive for use by the physician or other healthcare professional in conjunction with the prescription of medication to the patient.

For example, a physician or other healthcare professional may not be able to readily identify a medication that is to be prescribed utilizing a prescription module of an electronic health record in an instance in which the physician or other healthcare professional does not know the exact name of the medication. For example, in instances in which the medication is no longer available under the name known by the physician or other healthcare professional, such as in instances in which the medication is no longer marketed under the brand name, or in instances in which the physician or other healthcare professional is uncertain regarding the spelling of the medication, a prescription module of an electronic health record may provide only limited, if any, assistance to the physician or other healthcare professional in relation to the identification of the medication.

### BRIEF SUMMARY

A method, computing device and computer program product are provided in accordance with example embodiments of the present invention in order to provide medication information in conjunction with an electronic health record of a patient. The method, computing device and computer program product of an example embodiment provide an intuitive interface for a physician or other healthcare professional in order to review the medication history of a patient and to prescribe medication to the patient in an efficient manner. In this regard, the method, computing device and computer program product of an example embodiment may permit a physician or other healthcare professional to readily view the current medications for the patient, the historical medications taken by the patient and the favorite medications to be prescribed by the physician or other healthcare professional, thereby providing a common interface from which to determine the medication history of the patient and to prescribe medications to the patient.

In one embodiment, a method is disclosed for providing medication information in conjunction with an electronic health record of a patient. The method includes permitting a user to access the electronic health record of the patient and displaying a medication catalog within the electronic health record of the patient. The medication catalog includes a current medication listing of one or more current medications for the patient, a historical medication listing of one or more historical medications for the patient and a favorites listing of one or more favorite medications of the user. The method also includes receiving user input via a selection of a respective medication included in the current medication list, the historical medication listing or the favorites listing in order to alter a prescription of the patient.

The method of one embodiment may also include modifying at least two of the current medication listing, the historical medication listing and the favorites listing in order to move the respective medication from one listing to another listing in response to the selection of the respective medication and alteration of the prescription of the patient. The method may display the medication catalog by displaying a formulary status and/or copay data with one or more of the current medications, the historical medications or the favorites medications. The method of one embodiment may also include receiving a search query and determining one or more of the current medications, historical medications or the favorite medications that satisfy the search query. The method of this embodiment also includes displaying search results including the one or more of the current medications, the historical medications or the favorite medications that are determined to satisfy the search query. In this embodiment, the method may also include determining one or more medications that are available and that satisfy the search query such that the one or more medications that are available and that satisfy the search query may be additionally displayed. The method of this embodiment may also include extending the search query for a medication to include one or more equivalent brand names, generic names or nicknames for the medication. In one embodiment, the receipt of the search string may include receiving a search string, displaying one or more suggestions based upon the search string with the one or more suggestions being ordered based upon relevance to the search string, and receiving user selection of a respective suggestion.

In another embodiment, a computing device is disclosed for providing medication information in conjunction with an electronic health record of a patient. The computing device includes processing circuitry configured to permit a user to access the electronic health record of the patient and to display a medication catalog within the electronic health record of the patient. The medication catalog includes a current medication listing of one or more current medications for the patient, a historical medication listing of one or more historical medications for the patient and a favorites listing of one or more favorite medications of the user. The processing circuitry is also configured to receive user input via a selection of a respective medication included in the current medication listing, the historical medication listing or the favorites listing in order to alter a prescription of a patient.

The processing circuitry of one embodiment is further configured to modify at least two of the current medication listing, the historical medication listing and the favorites listing in order to move the respective medication from one listing to another listing in response to the selection of the respective medication and alteration of the prescription of the patient. The processing circuitry of one embodiment is configured to display the medication catalog by displaying a formulary status and/or copay data with one or more of the current medications, historical medications or favorite medications.

The processing circuitry of one embodiment is further configured to receive a search query, determine one or more of the current medications, historical medications or the favorite medications that satisfy that search query and display search results including the one or more of the current medications, the historical medications or the favorite medications that are determined to satisfy the search query. The processing circuitry of this embodiment may be configured to determine one or more medications that are available and that satisfy the search query, and to display the search results by additionally displaying the one or more medications that are available and that satisfy the search query. The processing circuitry of this embodiment may also be configured to expand the search query for a medication to include one or more equivalent brand names, generic names or nicknames for the medication. The processing circuitry of this embodiment may also be configured to receive the search string by receiving a search string, displaying one or more suggestions based upon the search string with the one or more suggestions being ordered based upon relevance to the search string, and receiving user selection of a respective suggestion.

In a further embodiment, a computer program product is disclosed for providing medication information in conjunction with an electronic health record of a patient. The computer program product includes a non-transitory computer-readable storage medium having program code portions stored thereon with the program code portions configured, upon execution, to permit a user to access the electronic health record of the patient and to display a medication catalog within the electronic health record of the patient. The medication catalog includes a current medication listing of one or more current medications for the patient, a historical medications listing of one or more historical medications for the patient and a favorites listing of one or more favorite medications of the user. The program code portions are also configured, upon execution, to receive user input via a selection of a respective medication included in the current medication listing, the historical medication listing or the favorites listing in order to alter a prescription of the patient.

The program code portions of one embodiment are further configured, upon execution, to modify at least two of the current medication listing, the historical medication listing and the favorites listing in order to move the respective medication from one listing to another listing in response to the selection of the respective medication and alteration of the prescription of the patient. The program code portions of one embodiment are also configured, upon execution, to receive a search query, determine one or more of the current medications, historical medications or the favorite medications that satisfy the search query and display search results including the one or more of the current medications, the historical medications or the favorite medications that are determined to satisfy the search query. The program code portions of this embodiment may be configured to determine one or more medications that are available and that satisfy the search query such that the display of the search results may additionally include the one or more medications that are available and that satisfy the search query.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of a computing device that may be specifically configured in accordance with an example embodiment of the present invention;

FIG. 2 is a flow chart of the operations performed, such as by the computing device of FIG. 1, in order to provide medication information in conjunction with an electronic health record of a patient in accordance with an example embodiment of the present invention;

FIG. 3 is an example of a medication catalog that may be displayed in accordance with an example embodiment of the present invention;

FIG. 4 is a flow chart illustrating the operations performed, such as by the computing device of FIG. 1, in order to search a medication catalog in accordance with an example embodiment of the present invention; and

FIGS. 5-7 are examples of a medication catalog and the results of a search of the medication catalog in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A method, computing device and computer program product are provided in accordance with an example embodiment of the present invention in order to provide medication information in conjunction with an electronic health record of a patient. In this regard, an electronic health record may include a variety of information associated with a patient, such as demographic information including the name, date of birth, mailing address and the like of a patient, insurance information associated with the patient and information regarding one or more encounters, such as office visits, hospital stays, laboratory tests, imaging appointments or the like. The electronic health record may also include one or more documents, such as notes from a prior encounter, results of a laboratory test, an imaging study, etc. In accordance with an example embodiment, the electronic health record also includes medication information including information relating to the current medications of the patient, historical medications of the patient and the medications that are most frequently prescribed by a user who has accessed the electronic health record, such as a physician or other healthcare professional. As such, the method, apparatus and computer program product of an example embodiment may permit the user to readily determine the medication history of the patient from a review of the electronic health record and to efficiently write a prescription or modify an existing prescription from within the electronic health record of the patient.

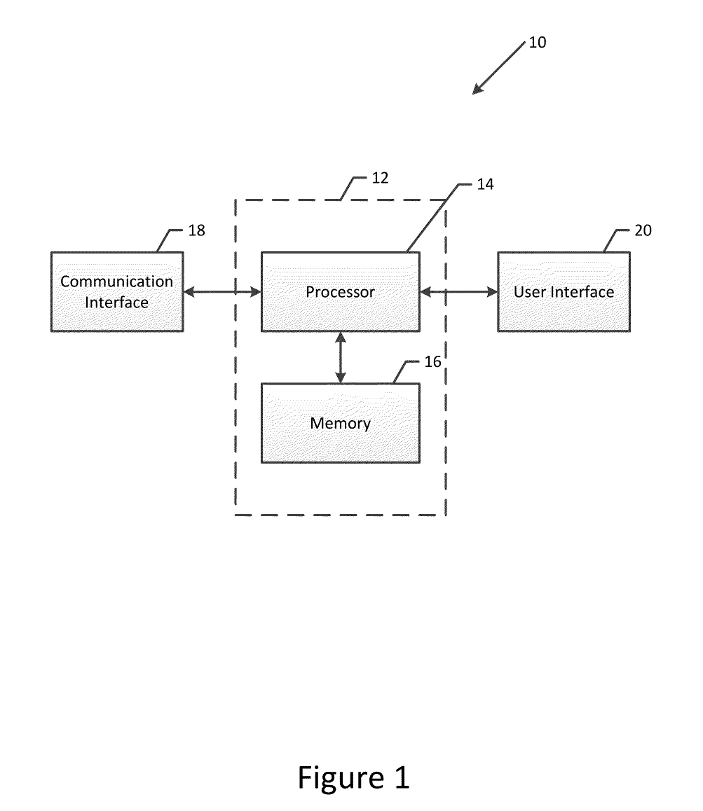

Referring now to FIG. 1, a computing device that may be specifically configured in order to provide medication information in conjunction with an electronic health record of a patient is provided in accordance with an example embodiment of the present invention. The computing device is capable of functioning in a health information infrastructure and may be embodied by one or more personal computers, laptop computers, notebook computers, tablet computers, computer workstations, mobile terminals, e.g., smart phones, personal digital assistants or the like. As described below, the computing device may be configured to implement and/or otherwise support implementation of various example embodiments. However, it should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The computing device 10 may include or otherwise be in communication with processing circuitry 12 that is configurable to perform actions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 12 may include a processor 14 and, in some embodiments, such as that illustrated in FIG. 1, may further include memory 16. The processing circuitry may be in communication with or otherwise control a communication interface 18 and, in some embodiments, a user interface 20. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device 10 as described herein. The plurality of processors may be embodied on a single computing device or distributed across a plurality of computing devices collectively configured to function as the computing device. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 16 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices collectively configured to function as the computing device 10. The memory may be configured to store information, data, applications, instructions and/or the like for enabling the computing device to carry out various functions in accordance with one or more example embodiments. For example, the memory may be configured to buffer input data for processing by the processor 14. Additionally or alternatively, the memory may be configured to store instructions for execution by the processor. As yet another alternative, the memory may include one or more databases that may store a variety of files, contents or data sets, such as electronic health records for a plurality of patients. Among the contents of the memory, applications may be stored for execution by the processor in order to carry out the functionality associated with each respective application. In some cases, the memory may be in communication with one or more of the processor, user interface 20, or communication interface 18 via a bus or buses for passing information among components of the computing device.

The user interface 20 may be in communication with the processing circuitry 12 to receive an indication of a user input at the user interface and/or to provide an audible, visual, mechanical or other output to the user. As such, the user interface may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the computing device 10 is implemented on a server or other network device, aspects of the user interface may be limited, or the user interface may even be eliminated. For example, the computing device may act as a server or host device, with a user interface provided by a client application.

The communication interface 18 may include one or more interface mechanisms for enabling communication with other devices and/or networks, such as with one or more servers or other network devices that may store and provide access to the electronic health records of a plurality of patients. In some cases, the communication interface may be any means such as a device or circuitry embodied in either hardware, or a combination of hardware and software that is configured to receive and/or transmit data from/to a network and/or any other device or module in communication with the processing circuitry 12. By way of example, the communication interface may be configured to enable the computing device 10 to communicate with a server or other network device via a wireless network, such as a wireless local area network (WLAN), cellular network, and/or the like. Additionally or alternatively, the communication interface may be configured to enable the computing device to communicate with the server or other network device via a wireline network. In some example embodiments, the communication interface may be configured to enable communication between the computing device and one or more servers or other network devices via the internet. Accordingly, the communication interface may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described computing device 10 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

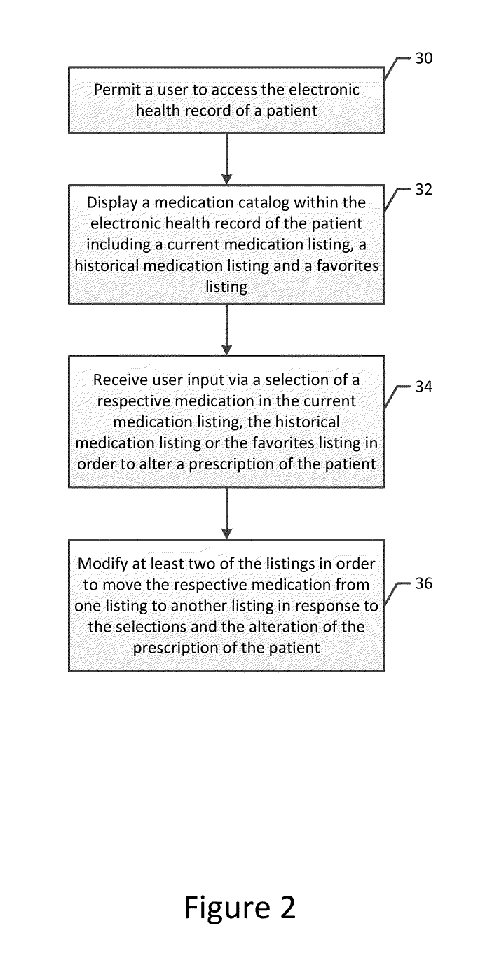

Referring now to FIG. 2, the operations performed, such as by the computing device 10 of FIG. 1, in order to provide medication information in conjunction with an electronic health record of a patient are depicted. As shown in block 30 of FIG. 2, the computing device may include means, such as the processing circuitry 12, the processor 14, the memory 16, the communication interface 18 or the like, for permitting a user to access the electronic health record of a patient. In this regard, a user, such as a physician or other healthcare professional, who has authorization to access the electronic health record of the patient may request the electronic health record, such as by providing a request for the electronic health record via the user interface 20. In response, the computing device may access the electronic health record and may cause the electronic health record to be displayed, such as upon user interface. The computing device may access the electronic health record in various manners including, for example, retrieval of the electronic health record from memory 16 in instances in which the electronic health record or a copy of the electronic health record is stored locally. Alternatively, the computing device may access the electronic health record from a remote storage location, such as a server or other network storage device, via the communication interface.

The electronic health record may be displayed such that the user can review and otherwise have access to the various types of information included within the electronic health record including demographic information associated with the patient, insurance information, information regarding previous encounters and associated documents, such as notes from prior encounters, image studies, laboratory results, etc. In accordance with an example embodiment, the electronic health record includes medication information including information regarding the prescriptions that are currently or have historically been written for the patient. In this regard, the computing device 10 may include means, such as the processing circuitry 12, the processor 14, the user interface 20 or the like, for displaying a medication catalog within the electronic health record of the patient. See block 32 of FIG. 2. The medication catalog includes a current medication listing of zero or more current medications for the patient, a historical medication listing of zero or more historical medications for the patient and a favorites listing of zero or more favorite medications of the user. In this regard, the current medications are those medications for which the patient has a current and active prescription. The historical medications are those medications that have previously been prescribed for the patient, but which are not currently being taken by the patient since the prescription has lapsed or otherwise been completed. And, the favorite medications are those medications that are most frequently prescribed by the user, such as a physician or other healthcare professional. In this regard, the favorite medications are the medications that are most frequently prescribed by the user regardless of whether the favorite medications are currently or have previously been prescribed to the patient. As such, the favorite medications of one embodiment include one or more medications that have never been prescribed to the patient and, as a result, are not included within the current medication listing or the historical medication listing. However, the favorite medications may include one or more medications that are currently prescribed for the patient or have previously been prescribed for the patient and, as such, may include one or more medications that are also included within the current medications listing or the historical medication listing.

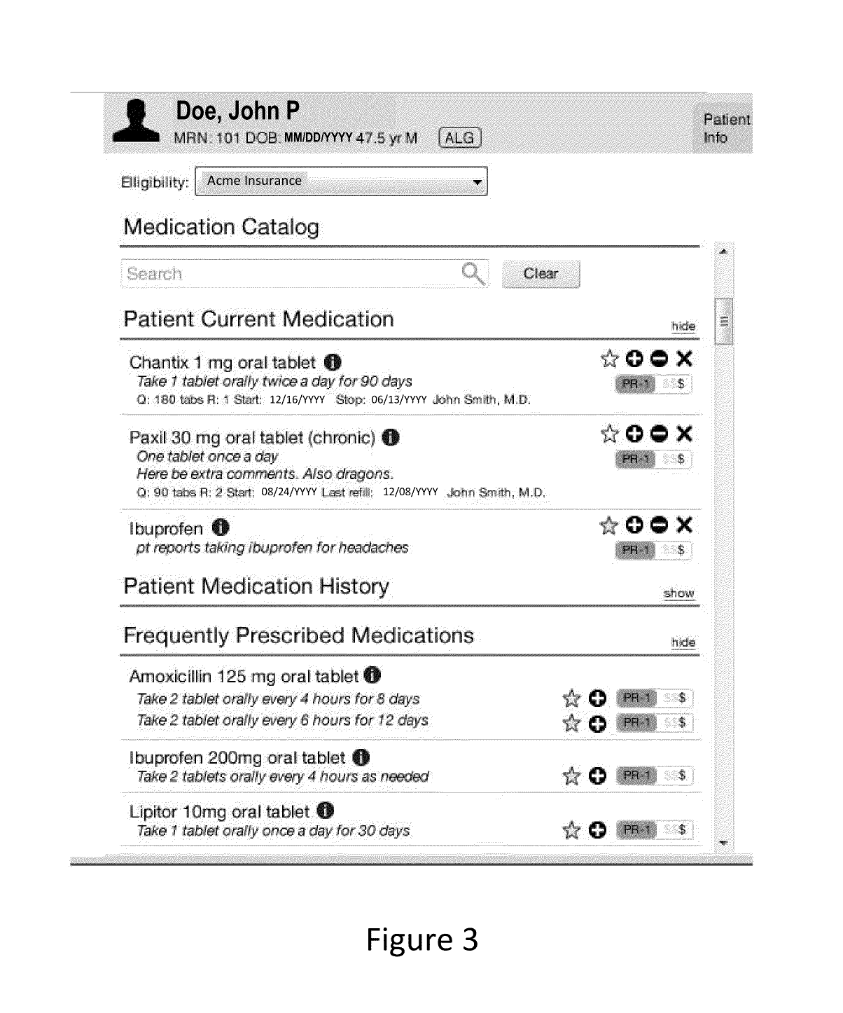

Referring now to FIG. 3, an example of the medication information that may be provided in accordance with an example embodiment of the present invention in conjunction with an electronic health record of a patient is depicted. In this regard, the electronic health record of the patient, John P. Doe, includes some demographic information, e.g., date of birth and age, and information regarding the insurance of the patient, namely, Acme Insurance, as well as medication information in the form of a medication catalog. As shown in this example, the medication catalog includes three listings, namely, a current medication listing termed Patient Current Medication, a historical medication listing termed Patient Medication History and a favorites listing termed Frequently Prescribed Medication. In the illustrated embodiment, the historical listing is collapsed so such that only the heading is presented. In order to view the historical medications included in the historical medication listing, the historical listing may be expanded, such as by actuation of the “show” link in the embodiment of FIG. 3. The other listings, e.g., the current medication listing and/or the favorites listing, may be similarly collapsed and expanded in other embodiments. Although each of the current medication listing, the historical medication listing and the favorites listing may include one or more medications, one or more of the listings may not include any medications, such as in an instance in which the patient does not have any current prescriptions such that the current medication listing is empty. In an instance in which a listing has not medications, the listing may be depicted, such as by displaying the name of the listing, e.g., Patient Current Medication, but no medications will be displayed thereafter.

Although each listing may include any number of medications, the current medication listing of the embodiment of FIG. 3 includes three medications. For each medication, the current medication listing and the historical medication listing may include information, such as the patient instructions, quantity, refills, prescriber, start date, stop date and the last renewal date, for each medication. In addition, the current medication listing and the historical medication listing may include the formulary status. In this regard, a formulary is a list of medications that have been approved for reimbursement by a payer, such as the patient's insurance company. As such, the formulary status, such as PR-1, may provide an indication of whether or not the medication has been approved for reimbursement by a payer. Furthermore, the current medication listing and the historical medication listing may include copay data, such as illustrated by one or more dollar signs, which provides an indication of the relative cost of the medication. In order to provide the formulary status and/or copay data, the formulary status and copay data for the patient's insurance company may be accessible, such as by being stored in memory 16. Based upon the formulary status and the copay data, a user may be judicious in prescribing medications to focus upon those that are relatively cost effective or may at least may alert the patient upfront as to the medication not being approved for reimbursement and/or having a larger copay. Likewise, the favorites listing may include information associated with the medications including patient instructions, quantity, refills, formulary status and/or copay data.

Within a respective listing, such as the current medication listing, the historical medication listing or the favorites listing, the medications may be arranged in various manners, such as alphabetically. With respect to the favorites listing, for example, the favorite medications may first be grouped by medication name and then listed alphabetically by the medication name. For each medication name, the different form, route and strength of the medication may be displayed to facilitate user selection of the desired medication.

As shown in block 34 of FIG. 2, a computing device 10 may include means, such as the processing circuitry 12, the processor 14, the user interface 20 or the like, for receiving user input via a selection of a respective medication included in the current medication listing, the historical medication listing or the favorites listing in order to alter a prescription of the patient. The prescription of the patient may be altered in any of several different manners. For example, user input may be provided in conjunction with a current medication in order to discontinue the medication or to renew the medication. Additionally or alternatively, user input may be received for one or more medications in the historical medication listing or the favorites listing that serves to prescribe the respective medications. The user input may be provided in various manners. In the embodiment depicted in FIG. 3, the user may actuate the +icon in order to prescribe a medication or renew a prescription for a medication, and may actuate the −icon in order to discontinue a medication.

Still further, user input may receive for one or more medications in the current medication listing and/or the historical medication listing that causes the respective medication to be added to the favorites listing. By way of example, a user may actuate the star associated with the medication in the current medication listing or the historical medication listing in order to add the medication to the favorites listing. Conversely, user input may be provided to remove a medication from the favorites listing, such as by actuation of the star associated with the respective medication in the favorites listing.

As such, the computing device 10 may include means, such as the processing circuitry 12, the processor 14, the user interface 20 or the like, for modifying at least two of the current medication listing, the historical medication listing and the favorites listing in order to move the respective medication that has been selected from one listing to another listing in response to the selection of the respective medication and alteration of the prescription of the patient. See block 36 of FIG. 2. For example, a medication that previously appeared in the historical medication listing or the favorites listing may be moved to the current medication listing in response to the user prescribing the medication to the patient. Conversely, a medication that previously appeared in the current medication listing may be moved to the historical medication listing in response to the user discontinuing the medication. Thus, the medication catalog provided by the method, computing device and computer program product of an example embodiment facilitates the user's review of the medication history of the patient and permits efficient modifications to the patient's prescriptions.

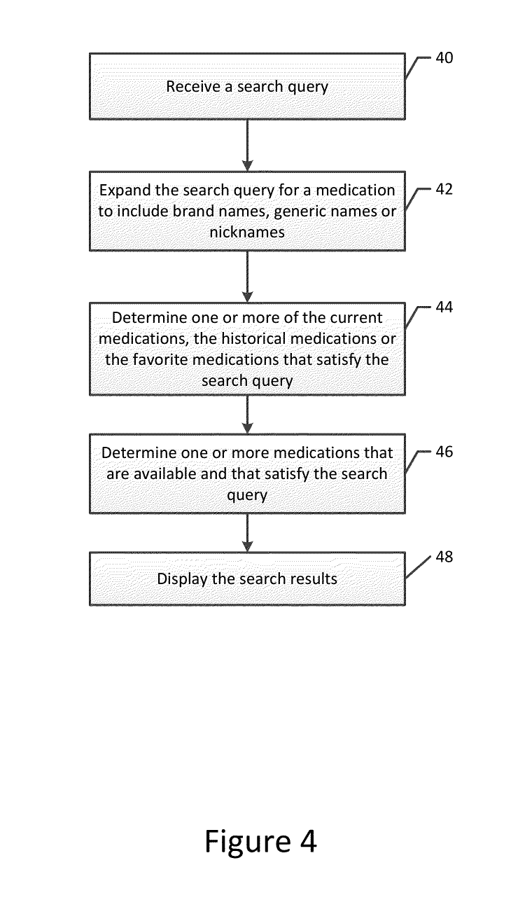

The method, computing device 10 and computer program product of an example embodiment may also provide for search functionality with respect to the medications included within the medication catalog. In this regard and as depicted in block 40 of FIG. 4, the computing device may include means, such as the processing circuitry 12, the processor 14, the user interface 20 or the like, for receiving a search query. Although the search query may be entered in various manners, a field may be defined, such as shown in the example of FIG. 3, in which one or more search terms may be entered in the form of a search string. The medication catalog may be searched in various manners and, as such, the search query may take various forms including the name of a medication, such as brand name, generic name, nickname, etc., a condition that may be treated by a medication and/or a therapeutic class of a medication.

In one embodiment, the computing device 10, such as the processing circuitry 12, the processor 14 or the like, may provide, e.g., display one or more suggestions based upon the search string with the suggestions ordered based upon the relevancy of the suggestions to the search string. For example, the most relevant set of suggestions may be those that begin with an identical string to the search string, the set of suggestions with an intermediate relevancy may be those that include, but do not begin with, an identical string to the search string and the least relevant set of suggestions may be those that include a similar, but not identical, string to the search string. In this regard, the computing device, such as the processing circuitry, the processor or the like, may determine similarity in various manners, such as in accordance with a predefined algorithm, such as a double metaphone algorithm. Within each set, the suggestions may also be ordered, such as alphabetically. The set of suggestions that include a similar string may be ordered, for example, in various manners including in an ascending fashion by the absolute value of the difference between the length of the string of characters entered as the search query and the length of the string of characters that is included in the suggestion such that those suggestions having strings of characters that are closer in length to the search query will be considered more similar and may appear higher in the listing. In order to facilitate the user's review of the suggestions, the portions of the suggestions that are identical to the search string may be bolded or otherwise highlighted. In response to the suggestions, the user may select one of the suggestions so as to provide the search query.

In one embodiment, the computing device 10 may include means, such as the processing circuitry 12, the processor 14 or the like, for expanding the search query for a medication to include one or more equivalent brand names, generic names or nicknames for the medication. See block 42 of FIG. 4. In this regard, the search query may initially provide a name of the medication that is the object of the search and the computing device, such as the processing circuitry, the processor or the like, may identify equivalent brand names, generic names or nicknames that should also be searched in order to provide more comprehensive search results. In this regard, the equivalent brand names, generic names and nicknames for a medication may be stored, such as by memory 16, such that the computing device, such as the processing circuitry, the processor or the like, may identify the equivalent brand names, generic names and nicknames in response to the name of a medication that is received as a search query.

In this embodiment, the computing device 10 may also include means, such as the processing circuitry 12, the processor 14 or the like, for determining one or more of the current medications, the historical medications or the favorite medications that satisfy the search query, such as, in one embodiment, an expanded search query including equivalent brand names, generic names or nicknames. See block 44 of FIG. 4. In this regard, the computing device, such as the processing circuitry, the processor or the like, may filter the current medications, the historical medications and the favorite medications based upon the search query in order to identify any one or more of the current medications, historical medications or the favorite medications that satisfy the search query, such as based upon the name of the medication, the condition treated by the medication, the therapeutic class of the medication or the like. As such, the computing device may have access to information, such as may be stored in memory 16, regarding the condition treated by the various medications and the therapeutic class of the medications. The computing device of this embodiment may also include means, such as the processing circuitry, the processor, the user interface 20 or the like, for displaying search results including the one or more of the current medications, historical medications or the favorite medications that are determined to satisfy the search query. See block 48 of FIG. 4. As such, the user may quickly and efficiently determine if a patient was taking or has taken a medication that satisfies the search query and, if so desired, may provide an efficient mechanism by which the user may prescribe one or more of the medications that are identified as a result of the search query for a patient.

The search results, e.g., the names of the medications and associated medication information, may be displayed in various manners. For example, in instances in which the search query is based upon the condition treated by the medication or the therapeutic class of the medication, the search results may be presented alphabetically. In one embodiment, the search results that are determined by the computing device 10 may include not only the relevant medications from the current medication listing, the historical medication listing and the favorites listing, but also available medications that both satisfy the search query and that are available, such as medications that are currently on the market in a predefined geographical region, e.g., the United States, regardless of whether the available medications are included in the current medication listing, the historical medication listing or the favorites listing. As such, the computing device, such as the processing circuitry 12, the processor 14 or the like, may have access to a database of medications that are available. The database of available medications may be stored by memory 16 or may be accessible via the communication interface 18, such as from a server or other network entity.

In this embodiment, the computing device 10, such as the processing circuitry 12, the processor 14, the user interface 20 or the like, may cause the available medications that both satisfy the search query and that are available to be determined and to be included for display in the search results in addition to the medications included in the current medication listing, the historical medication listing and the favorites listing that satisfy the search query. See block 46 of FIG. 4. The available medications that are included in the search results may be identified in various manners including by highlighting or bolding the available medications in the search results or by grouping the available medications, such as at the beginning of the search results, at the end of the search results or the like.

In an instance in which the available medication identically matches the search query, the medication by the name utilized in the search query may be listed first in the respective listing of available medications and expanded with any other equivalent brand name or generic medications that satisfy, but do not identically match the search query being listed alphabetically thereafter so as to define respective medication groups. In one embodiment, the entry for a respective medication group, such as a medication group for a medication that satisfies but does not identically match the search query, may be collapsed so as just to include the name of the medication without any additional medication information. In an instance in which a medication group is collapsed, the formulary status and abbreviated copay data may be shown for the medication within the medication group with the most favorable formulary status, that is, the medication, if any, that has been approved for reimbursement. As such, a user may quickly identify generic or brand name versions of the medication that is to be prescribed so as to be able to provide the least expensive option for the patient.

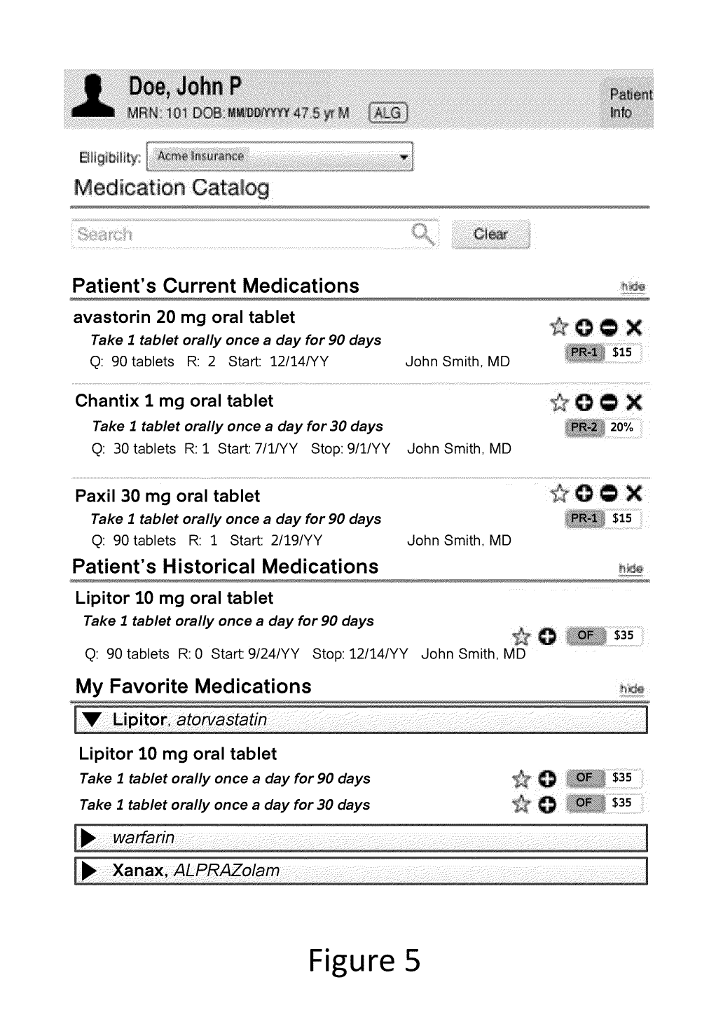

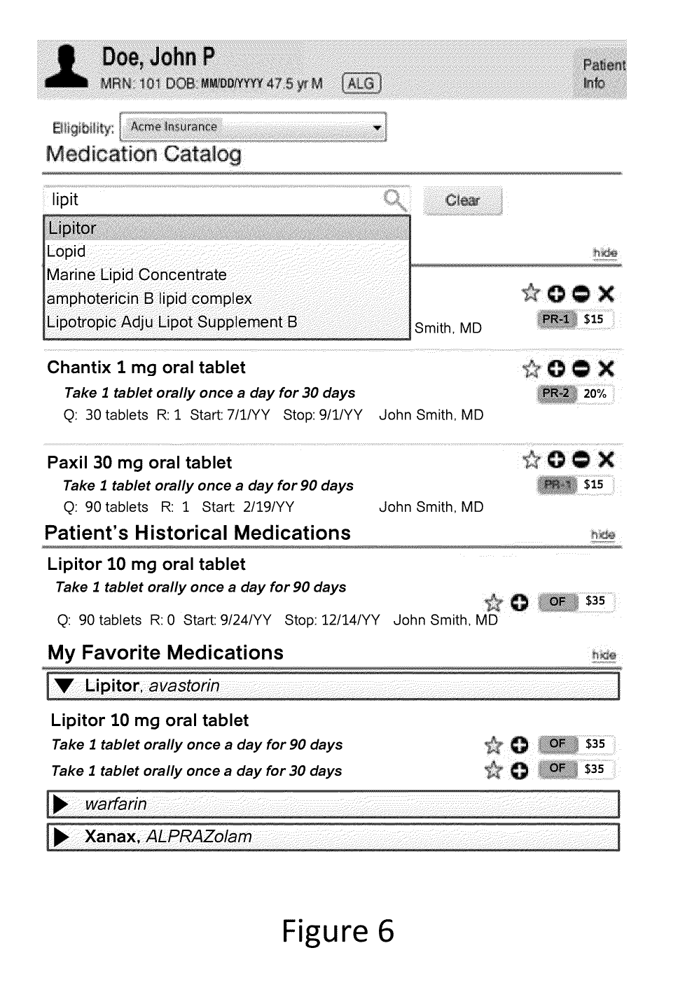

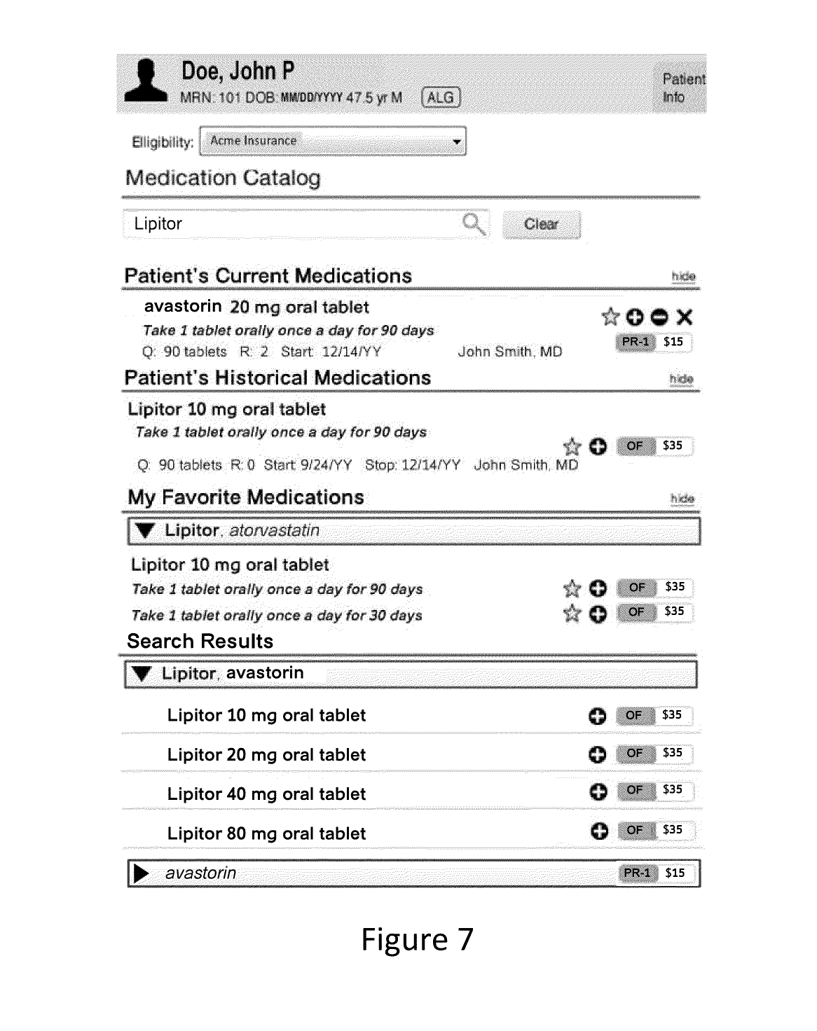

By way of example, FIG. 5 depicts a medication catalog that includes a current medication listing termed Patient's Current Medications that includes atorvastatin (a generic version of Lipitor), Chantix and Paxil, a historical medication listing termed Patient's Historical Medications that includes Lipitor and a favorites listing termed My Favorite Medications including Lipitor, warfarin and Xanax. With respect to the medications in the favorites listing, the medications are grouped by medication name (including both branded and generic medications) with the different forms, routes and strengths of the medication also being provided. As shown in FIG. 6, a search string may be input, such as “lipit”. A plurality of suggestions may be provided with the suggestions ordered based upon relevancy as described above. In response to the selection by the user of Lipitor as the search query, the computing device 10, such as the processing circuitry 12, the processor 14 or the like, may expand the search query to include one or more equivalent brand names, generic names or nicknames for Lipitor, such as atorvastatin which is the generic version of Lipitor. The resulting search results depicted in FIG. 7 may therefore identify atorvastatin in the current medication listing and Lipitor in both the historical medication listing and the favorites listing. FIG. 7 also illustrates a listing of available medications that satisfy the search query, such as various forms of Lipitor and atorvastatin. In the illustrated embodiment, the available medication that identically matches the search query, e.g., Lipitor, is expanded so as to display the different forms, routes and strengths and the available medication, e.g., atorvastatin, that satisfies the search query but is not identical to the search query, such as by matching an expanded version of the search query, may be displayed in collapsed manner (subject to expansion in response to selection by the user).

In an instance in which the computing device 10, such as the processing circuitry 12, the processor 14 or the like, does not identify any results in response to a search query, the computing device may cause a predefined message to be provided, such as by displaying a message that provides tips with respect to the search query. For example, the predefined message may suggest the use of a different string of characters as the search query, confirmation of the spelling, entry of the entire medication name or elimination of form, route or strength information from the search query.

In one embodiment, the computing device 10, such as the processing circuitry 12, the processor 14 or the like, may identify any of the medications included in the medication catalog to which the patient is allergic. Additionally or alternatively, the computing device, such as the processing circuitry, the processor or the like, may identify any of the medications included in the medication catalog that had previously been prescribed for the patient, but that failed to work. As such, the computing device, such as the processing circuitry, the processor, the user interface 20 or the like, may flag those medications for which the user has an allergy and/or that failed to previously work for the patient such that the user may tailor the prescription for the patient so as to avoid those medications to which the patient has an allergy and/or that have failed in the past.

As described above, FIGS. 2 and 4 illustrate flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 16 of a computing device 10 and executed by processing circuitry 12 in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 12 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method of providing medication information in conjunction with an electronic health record of a patient, the method comprising:
permitting, with processing circuitry, a user to access the electronic health record of the patient;
displaying a medication catalog within the electronic health record of the patient, wherein the medication catalog includes a current medication listing of one or more current medications for the patient, a historical medication listing of one or more historical medications for the patient and a favorites listing of one or more favorite medications of the user; and
receiving user input via a selection of a respective medication included in the current medication listing, the historical medication listing or the favorites listing in order to alter a prescription of the patient.

2. A method according to claim 1 further comprising modifying at least two of the current medication listing, the historical medication listing and the favorites listing in order to move the respective medication from one listing to another listing in response to the selection of the respective medication and alteration of the prescription of the patient.

3. A method according to claim 1 wherein displaying the medication catalog comprises displaying a formulary status with one or more of the current medications, the historical medications or the favorite medications.

4. A method according to claim 1 wherein displaying the medication catalog comprises displaying copay data with one or more of the current medications, the historical medications or the favorite medications.

5. A method according to claim 1 further comprising:
receiving a search query;
determining one or more of the current medications, the historical medications or the favorite medications that satisfy the search query; and
displaying search results including the one or more of the current medications, the historical medications or the favorite medications that are determined to satisfy the search query.

6. A method according to claim 5 further comprising determining one or more medications that are available and that satisfy the search query, and wherein displaying the search results comprises additionally displaying the one or more medications that are available and that satisfy the search query.

7. A method according to claim 5 further comprising expanding the search query for a medication to include one or more equivalent brand names, generic names or nick names for the medication.

8. A method according to claim 5 wherein receiving the search query comprises:
receiving a search string;
displaying one or more suggestions based upon the search string with the one or more suggestions being ordered based upon relevance to the search string; and
receiving user selection of a respective suggestion.

9. A computing device for providing medication information in conjunction with an electronic health record of a patient, the computing device comprising processing circuitry configured to:
permit a user to access the electronic health record of the patient;
display a medication catalog within the electronic health record of the patient, wherein the medication catalog includes a current medication listing of one or more current medications for the patient, a historical medication listing of one or more historical medications for the patient and a favorites listing of one or more favorite medications of the user; and
receive user input via a selection of a respective medication included in the current medication listing, the historical medication listing or the favorites listing in order to alter a prescription of the patient.

10. A computing device according to claim 9 wherein the processing circuitry is further configured to modify at least two of the current medication listing, the historical medication listing and the favorites listing in order to move the respective medication from one listing to another listing in response to the selection of the respective medication and alteration of the prescription of the patient.

11. A computing device according to claim 9 wherein the processing circuitry is configured to display the medication catalog by displaying a formulary status with one or more of the current medications, the historical medications or the favorite medications.

12. A computing device according to claim 9 wherein the processing circuitry is configured to display the medication catalog by displaying copay data with one or more of the current medications, the historical medications or the favorite medications.

13. A computing device according to claim 9 wherein the processing circuitry is further configured to:
receive a search query;
determine one or more of the current medications, the historical medications or the favorite medications that satisfy the search query; and
display search results including the one or more of the current medications, the historical medications or the favorite medications that are determined to satisfy the search query.

14. A computing device according to claim 13 wherein the processing circuitry is further configured to determine one or more medications that are available and that satisfy the search query, and wherein the processing circuitry is configured to display the search results by additionally displaying the one or more medications that are available and that satisfy the search query.

15. A computing device according to claim 13 wherein the processing circuitry is further configured to expand the search query for a medication to include one or more equivalent brand names, generic names or nick names for the medication.

16. A computing device according to claim 13 wherein the processing circuitry is configured to receive the search query by:
receiving a search string;
displaying one or more suggestions based upon the search string with the one or more suggestions being ordered based upon relevance to the search string; and
receiving user selection of a respective suggestion.

17. A computer program product for providing medication information in conjunction with an electronic health record of a patient, the computer program product comprising a non-transitory computer readable storage medium having program code portions stored thereon, the program code portions configured, upon execution, to:
permit a user to access the electronic health record of the patient;
display a medication catalog within the electronic health record of the patient, wherein the medication catalog includes a current medication listing of one or more current medications for the patient, a historical medication listing of one or more historical medications for the patient and a favorites listing of one or more favorite medications of the user; and
receive user input via a selection of a respective medication included in the current medication listing, the historical medication listing or the favorites listing in order to alter a prescription of the patient.

18. A computer program product according to claim 17 wherein the program code portions are further configured, upon execution, to modify at least two of the current medication listing, the historical medication listing and the favorites listing in order to move the respective medication from one listing to another listing in response to the selection of the respective medication and alteration of the prescription of the patient.

19. A computer program product according to claim 17 wherein the program code portions are further configured, upon execution, to:
receive a search query;
determine one or more of the current medications, the historical medications or the favorite medications that satisfy the search query; and
display search results including the one or more of the current medications, the historical medications or the favorite medications that are determined to satisfy the search query.

20. A computer program product according to claim 19 wherein the program code portions are further configured, upon execution, to determine one or more medications that are available and that satisfy the search query, and wherein the program code portions configured to display the search results comprise program code portions configured to additionally display the one or more medications that are available and that satisfy the search query.
